(19) United States
(12) Patent Application Publication
(10) Pub. No.: US 2001/0033084 A1
(43) Pub. Date: Oct. 25, 2001

(54) School bus driver shield

(76) Inventors: Constance S. Murray, Palm City, FL (US); Donald W. Zech, Lake Worth, FL (US)

Correspondence Address: Richard C. Litman, LITMAN LAW OFFICES, LTD., P.O. Box 15035, Arlington, VA, 22215, US

(21) Appl. No.: 09/782,251

(22) Filed: Feb. 14, 2001

Related U.S. Application Data
(60) Provisional application No. 60/185,107, filed on Feb. 25, 2000.

(51) Int. Cl. B60R 7/04

(52) U.S. Cl. 296/24.1; 296/37.16; 280/749

(57) ABSTRACT

A protective shield that prevents flying objects from striking a school bus driver. The protective shield has a plastic mesh body that allows unobstructed viewing of the occupants on a school bus. The school bus driver shield can be readily installed and removed. The protective shield is strong, durable, and lightweight.

### CROSS-REFERENCE TO RELATED APPLICATION

This application claims the benefit of U.S. Provisional Patent application Ser. No. 60/185,107, filed Feb. 25, 2000.

### BACKGROUND OF THE INVENTION

1. Field of the Invention

The present invention relates generally to shields. More specifically, the invention is a protective shield adapted to an interior driver portion of a school bus which protects a bus driver from potential flying debris.

2. Description of Related Art

School bus driver safety is of paramount importance because of all the young lives for which the school bus driver is responsible. Sometimes, the mischievous behavior of children poses a potential safety risk to the occupants of the school bus. Flying objects or missiles thrown by the children on the bus can inadvertently strike the school bus driver and pose such a distraction which can cause the school bus driver to lose control of the bus and potentially jeopardize the safety of its passengers.

The prior art describes a variety of barriers or partitions used to compartmentalize a vehicle, for example, a passive restraining barrier arrangement for vehicles is described in U.S. Pat. No. 4,906,020 issued on Mar. 6, 1990 to M. D. Haberer. The passive barrier arrangement includes a restraining barrier having a restraining shield bounded by three restraining shield belts. The restraining barrier is held in contact with the ceiling of the vehicle when in a stowed position by a breakaway fastening means. When a crash occurs, a pair of takeup belts are retracted into their retractors which brings the restraining barrier to a position in front of a driver or passenger sitting on the vehicle seat. U.S. Pat. No. 5,121,958 issued on Jun. 16, 1992 to M. J. Goeden describes a cargo freight partition. A cargo net formed of a substantially rectangular netting fabric with a length of nylon webbing material affixed to its perimeter is used to partition the rear compartment opening of a passenger vehicle.

A load restraining device is described in U.S. Pat. No. 5,288,122 issued on Feb. 22, 1994 to S. Pilhall. The rollably retractable cargo-retaining nets for vehicles employs a folding split backrests. Separate net containers are provided in the respective backrests and the nets are joined by a telescopic rod at an upper end which increases the safety and flexibility of the load restraining device. U.S. Pat. No. 5,551,726 issued on Sep. 3, 1996 to E. Ament describes a safety net system for a motor vehicle that separates a cargo compartment from a passenger compartment. The arrangement of the safety net system permits absorption of energy in case objects from the cargo compartment become dislodged upon abrupt deceleration of the vehicle.

None of the above inventions and patents, taken either singly or in combination, is seen to describe the instant invention as claimed.

### SUMMARY OF THE INVENTION

Accordingly, it is a principal object of the invention to provide a protective shield that protects a school bus driver from flying objects.

It is another object of the invention to provide a protective shield that permits a school bus driver to readily observe the actions of the bus occupants.

It is a further object of the invention to provide a protective shield that allows the school bus driver's hearing to be unencumbered.

Still another object of the invention is to provide a protective shield that is easy to install and remove.

It is an object of the invention to provide improved elements and arrangements thereof in a protective school bus driver shield for the purposes described which is inexpensive, dependable and fully effective in accomplishing its intended purposes.

The foregoing objectives are achieved in accordance with the present invention by providing a protective shield that screens a school bus driver from distractive and potentially harmful flying objects. The protective shield of the present invention assist a school bus driver in his driving without being distracted by debris such as pencils, gum, or bottle caps thrown by students riding the bus. The body of the protective shield is made of a plastic mesh material which provides a lightweight protective barrier without obscuring the school bus driver's ability to see and hear the students behind him.

The protective shield employs a plurality of hook and loop fasteners to secure the upper portion of the protective shield to the ceiling of the bus and a strip of self-adhesive material to secure the lower portion of the protective shield to the barrier behind the school bus driver's seat. The school bus driver shield is made of a transparent plastic mesh which allows the bus driver to have rearward vision and unobscured acoustics for hearing.

These and other objects of the present invention will become readily apparent upon further review of the following specification and drawings.

### BRIEF DESCRIPTION OF THE DRAWINGS

FIG. 1 is an environmental view of a school bus driver shield installed on a school bus according to the present invention.

FIG. 2 is a closeup view of a school bus driver shield installed in a school bus according to the invention.

FIG. 3 is a partially exploded view of a school bus driver shield according to the invention.

Similar reference characters denote corresponding features consistently throughout the attached drawings.

### DETAILED DESCRIPTION OF THE PREFERRED EMBODIMENTS

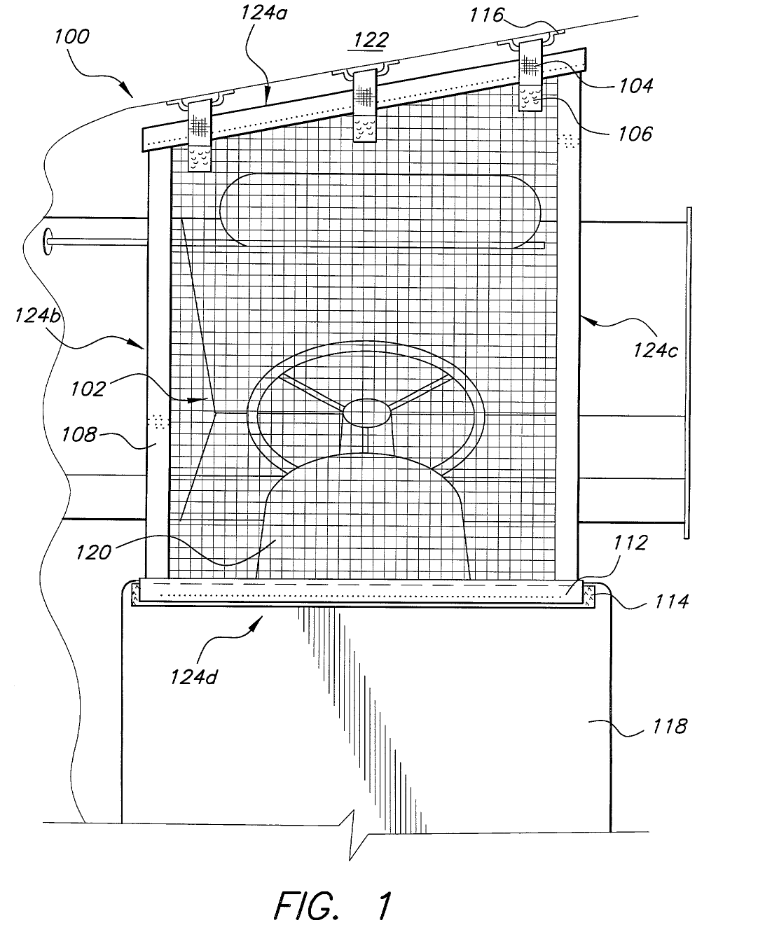

The present invention, as depicted in FIGS. 1-3, is a rear perspective of a school bus driver shield 100 that protects a school bus driver (not shown) from flying debris such as pencils, pens, or bottle caps thrown by students riding on the school bus. FIG. 1 is an environmental view of a protective school bus driver shield 100 installed on a school bus. The protective shield 100 of the present invention is secured to the ceiling 122 of the bus using a plurality of hook and loop fasteners 104 and 106. Three hook and loop fasteners 104, 106 are attached to three metal brackets 116 that are bolted to the ceiling 122 of the school bus and that serve as anchor points. In a preferred embodiment, the hook and loop fasteners 104, 106 are VELCRO. The hook and loop fastener tabs 104, 106 are sewn onto the protective shield 100. The fastener tabs 104, 106 consists of a hook portion 104 and a corresponding mating surface loop portion 106 connected end to end with the hook portion 104. The loop portion 106 is sewn directly onto the shield 100 while the free hook portion 104 is passed through the metal bracket 116 and folded back to releasably engage the loop portion mating surface 106. The protective shield 100 has a two inch vinyl trim 108 sewn around the periphery of the shield 100.

The body 102 of the protective shield 100 is made of a plastic see through or transparent mesh. The mesh arrangement of the body portion 102 of the protective shield 100 gives the school bus driver an unobstructed view from the rear-view mirror (not shown) or directly behind should the bus driver turn around to face the students riding on the bus. The plastic mesh material is preferably made of a lightweight but strong and durable material. In a preferred embodiment, the plastic mesh is green, however, any suitable color could be used. Accordingly, the protective shield 100 is secured to the barrier 118 behind the bus driver's seat 120 by means of a strip of fastening material 112 such as VELCRO. A one inch width strip of fastening material 112 (loop portion) is sewn across the base 124d of the protective shield 100 as shown in FIG. 1. A corresponding mating surface strip of hook and loop material 114 (hook portion) with an adhesive backing is applied to the upper boundary of the barrier 118 behind the bus driver's seat 120 and the protective shield 100 is secured to the barrier 118 by contacting the mating surfaces 112,114.

The protective school bus driver shield 100 has a distinctive shape to accommodate the interior contour of a school bus. The upper edge 124a of the protective shield 100 is sloped as depicted in FIG. 1 to accommodate the sloping of the ceiling 122 of the school bus. In a preferred embodiment, the sloped upper edge 124a is 27 inches in length, the longer side edge 124c is 36 inches, the shorter side edge 124b is 31 inches, and the lower edge 124d is 26 inches. The length of the one inch width fastening strip 112 at the base 124d of the shield 100 corresponds to the length of the lower edge 124d of the protective shield 100. The single strip of hook and loop material 114, such as VELCRO, attached to the barrier 118 behind the bus driver's seat 120 has a length of 29 inches and a width of one inch.

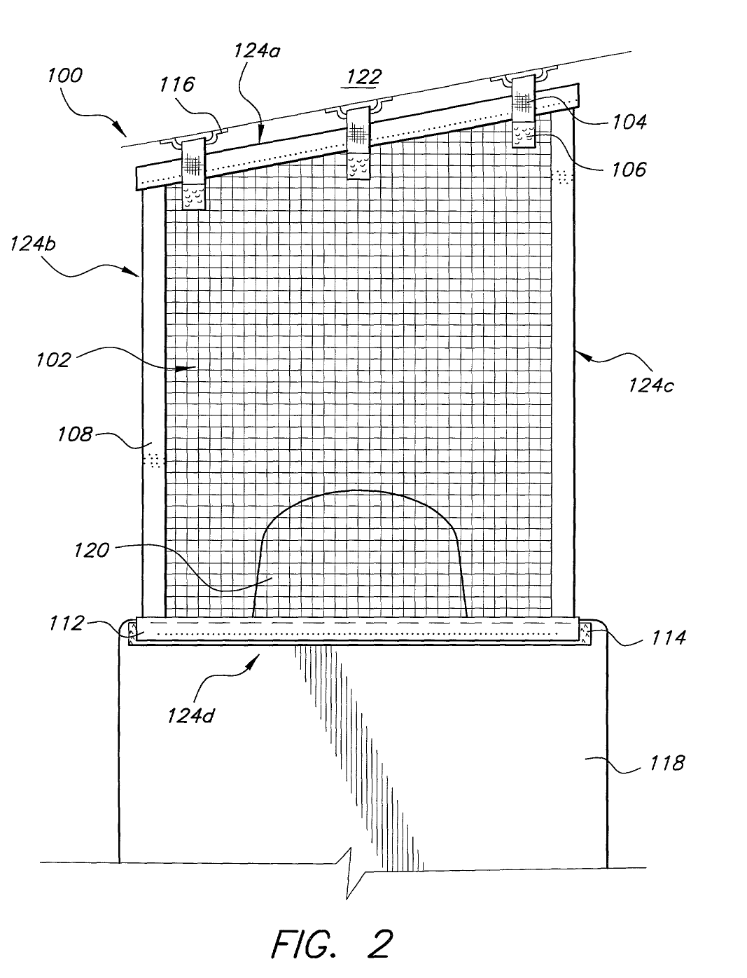

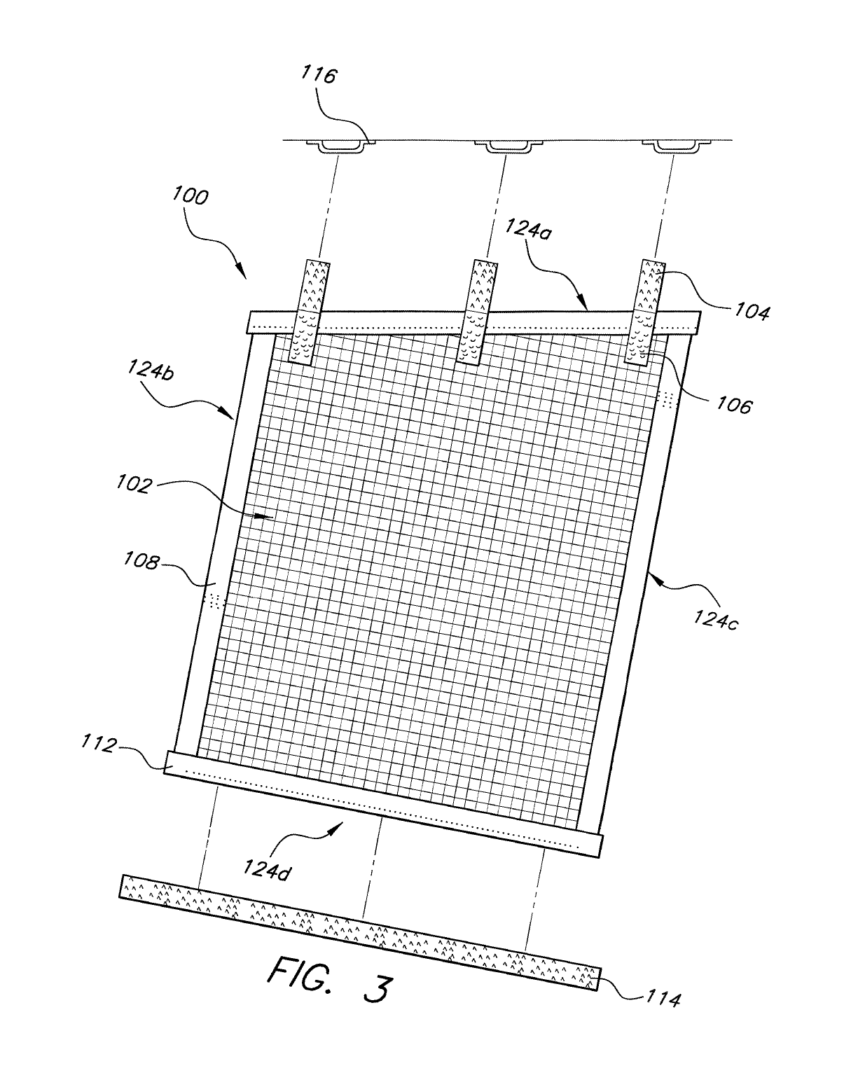

As diagrammatically illustrated in FIG. 2, there is shown a closeup view of the protective school bus driver shield 100 installed in a school bus in combination with a ceiling portion via brackets 116. FIG. 3 is a semi-exploded view illustrative of FIG., except that the school bus driver shield 100 is shown unattached.

The preferred embodiments of the present invention disclosed herein are intended to be illustrative only and are not intended to limit the scope of the invention. It should be understood by those skilled in the art that various modifications and adaptations of the present invention as well as alternative embodiments of the present invention may be contemplated.

It is to be understood that the present invention is not limited to the sole embodiments described above, but encompasses any and all embodiments within the scope of the following claims.

We claim:

1. A protective shield comprising:
a plastic mesh body with a vinyl trim periphery having a sloped upper edge;
a plurality of fastening tabs vertically disposed along said sloped upper edge; and
a strip of fastening material horizontally disposed along the lower edge of said body.

2. A protective shield according to claim 1, wherein each of said plurality of fastening tabs comprises a portion of loop fastening material and a portion of hook fastening material connected end to end, one of said portions being fixedly attached to said mesh body, said tab being foldable to releasably secure said loop portion to said hook portion.

3. A protective shield according to claim 2, wherein said fastening strip comprises hook and loop fastening material.

4. A protective shield comprising, in combination with at least one operative bus ceiling support:
a plastic mesh body with a vinyl trim periphery having a sloped upper edge;
a plurality of fastening tabs vertically disposed along said sloped upper edge; and
a strip of fastening material horizontally disposed along the lower edge of said body.

5. A protective shield according to claim 4, wherein each of said plurality of fastening tabs comprises a portion of loop fastening material and a portion of hook fastening material connected end to end, one of said portions being fixedly attached to said mesh body, said tab being foldable to releasably secure said loop portion to said hook portion.

6. A protective shield according to claim 5, wherein said fastening strip comprises hook and loop fastening material.
